(19) United States
(12) Patent Application Publication
(10) Pub. No.: US 2018/0059219 A1
(43) Pub. Date: Mar. 1, 2018

(54) MULTI-BEAM POSITION SENSING DEVICES

(71) Applicant: QUALCOMM Incorporated, San Diego, CA (US)

(72) Inventors: Linda Irish, San Diego, CA (US); William Henry Von Novak, San Diego, CA (US)

(21) Appl. No.: 15/253,443

(22) Filed: Aug. 31, 2016

(51) Int. Cl. G01S 7/484; G01S 17/06; G01J 1/08

(52) U.S. Cl. CPC G01S 7/484; G01J 1/08; G01S 17/06

(57) ABSTRACT

One disclosed method includes the steps of determining a plurality of modulation frequencies based on a plurality of received ambient light signals; causing a plurality of laser emitters to each transmit a laser pulse, each laser pulse modulated according to a modulation frequency of the plurality of modulation frequencies, each laser pulse having a different modulation frequency than each of the other modulated laser pulses; receiving a plurality of reflected laser pulses at a position sensing device, at least two of the plurality reflected laser pulses corresponding to the transmitted laser pulses; and determining positions of the received reflected laser pulses on the position sensing device.

### BACKGROUND

Laser-based, e.g., LIDAR, range finding devices may be used to detect the presence of, and distance to, objects within a field of view of the device. A laser device is positioned adjacent to an optical sensor at a predetermined offset. The laser device projects laser light into the field of view and reflected laser light is captured by the optical sensor. The captured reflected laser light may then be used to determine the location and distance to an object within the field of view.

### BRIEF SUMMARY

Various examples are described for multi-beam position sensing devices for 3D object sensing. One example method includes the steps of determining a plurality of modulation frequencies based on a plurality of received ambient light signals; causing a plurality of laser emitters to each transmit a laser pulse, each laser pulse modulated according to a modulation frequency of the plurality of modulation frequencies, each laser pulse having a different modulation frequency than each of the other modulated laser pulses; receiving a plurality of reflected laser pulses at a position sensing device, at least two of the plurality reflected laser pulses corresponding to the transmitted laser pulses; and determining positions of the received reflected laser pulses on the position sensing device.

Another disclosed example includes a system having a position sensing device comprising a light sensor; at least one lens positioned to direct received light onto the position sensing device; a plurality of laser emitters offset from the position sensing device; a plurality of laser drivers, each laser driver in communication with a different laser emitter of the plurality of laser emitters and configured to cause the respective laser emitter to emit a laser signal at a predetermined frequency; a plurality of beam deflectors, each beam deflector positioned to deflect laser light emitted by a corresponding laser emitter; an interference determination device comprising a spectrum analyzer in communication with the position sensing device to determine a frequency having an interference level below a predetermined interference threshold; a demodulator in communication with the position sensing device to receive signals from the position sensing device and to determine in-phase and quadrature signals based on the received signals; and a position determination device in communication with the demodulator to receive the in-phase and quadrature signals and to determine a position based at least in part on the in-phase and quadrature signals.

One disclosed system includes means for determining a plurality of modulation frequencies based on a plurality of received ambient light signals; means for causing a plurality of laser emitters to each transmit a laser pulse, each laser pulse modulated according to a modulation frequency of the plurality of modulation frequencies, each laser pulse having a different modulation frequency than each of the other modulated laser pulses; means for receiving a plurality of reflected laser pulses at a position sensing device, at least two of the plurality reflected laser pulses corresponding to the transmitted laser pulses; and means for determining positions of the received reflected laser pulses on the position sensing device.

A disclosed non-transitory computer-readable medium includes processor-executable program code to cause a processor to determine a plurality of modulation frequencies based on a plurality of received ambient light signals; cause a plurality of laser emitters to each transmit a laser pulse, each laser pulse modulated according to a modulation frequency of the plurality of modulation frequencies, each laser pulse having a different modulation frequency than each of the other modulated laser pulses; receive one or more signals from a position sensing device, the one or more signals based on a plurality of reflected laser pulses received at the position sensing device, at least two of the plurality reflected laser pulses corresponding to the transmitted laser pulses; and determine positions of the received reflected laser pulses on the position sensing device.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-3 show example systems for multi-beam position sensing devices for 3D imaging;

FIG. 4 shows an example system for determining modulation frequencies based on received ambient light signals;

FIG. 5 shows an example computing device;

FIG. 6 shows an example method for multi-beam position sensing devices for 3D imaging.

### DETAILED DESCRIPTION

Examples are described herein in the context of multi-beam position sensing devices for 3D object sensing. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

### Illustrative Example of Multi-Beam Position Sensing Devices for 3D Imaging

In this example, a multi-beam position sensing device (“MBPSD”) is installed on a roof of an autonomous vehicle. The MBPSD includes several laser emitters that are arranged to project laser light into a field of view via beam deflectors. The beam deflectors cause the emitted laser light to be projected in different directions over time, allowing the MBPSD to, for example, sweep laser light across the field of view. In this example, the beam deflectors cause the laser light to sweep across a field of view in front of the vehicle to identify other vehicles or objects in the path of the vehicle.

The laser emitters are arranged around a light sensor and at predetermined distances from the light sensor. In addition, each laser emitter is driven by a circuit that modulates the laser light according to a particular frequency, with each laser emitter modulated at a different frequency.

As laser light is projected into the field of view in front of the vehicle, some of the laser light may reflect off of objects, such as other vehicles, and back towards the MBPSD. Such reflected laser light may be sensed by the light sensor and, by determining the modulation frequency of the received light, the MBPSD can determine which laser emitter projected the light. More specifically, in this illustrative example, the MBPSD employs a position sensing diode which can provide signals indicating where a particular beam of laser light struck the sensor, providing further information that can be employed to determine the location of the object(s) in the field of view. Thus, the MBPSD determines where on the position sensing diode the reflected light struck, which may allow the MBPSD to determine the location of an object in the field of view. Further, by using multiple laser emitters, distance information determined from receiving reflected laser light from the different emitters can be used to better determine the location, size, and shape of objects within the MBPSD's field of view. Such information may be employed to determine a type of object or vehicle.

However, in an environment such as a highway, other vehicles may be employing position sensing devices that employ laser light or other types of light, which may interfere with the laser light emitted by MBPSD, even if the laser light is modulated. Thus, the MBPSD also includes a spectrum analyzer that analyzes ambient light, which is light received by the position sensing diode prior to emitting laser light from the MBPSD's laser emitters, or is light from a source other than the MBPSD's laser emitters (or reflected laser light originally emitted by the MBPSD's laser emitters). By providing ambient light sensor signals to the spectrum analyzer, the MBPSD can determine modulation frequencies of laser (or other) light, e.g. fluorescent light, being used in the immediate area. The output of the spectrum analyzer can then be used to identify modulation frequencies that are unlikely to experience much interference from laser light emitted by other laser sources in the vicinity. Thus, the MBPSD is able to identify usable modulation frequencies for its laser emitters to reduce the chances of interference from signals received from a laser emitter, e.g., on another vehicle.

This illustrative example is given to introduce the reader to the general subject matter discussed herein and the disclosure is not limited to this example. The following sections describe various additional non-limiting examples and examples of multi-beam position sensing devices for 3D imaging.

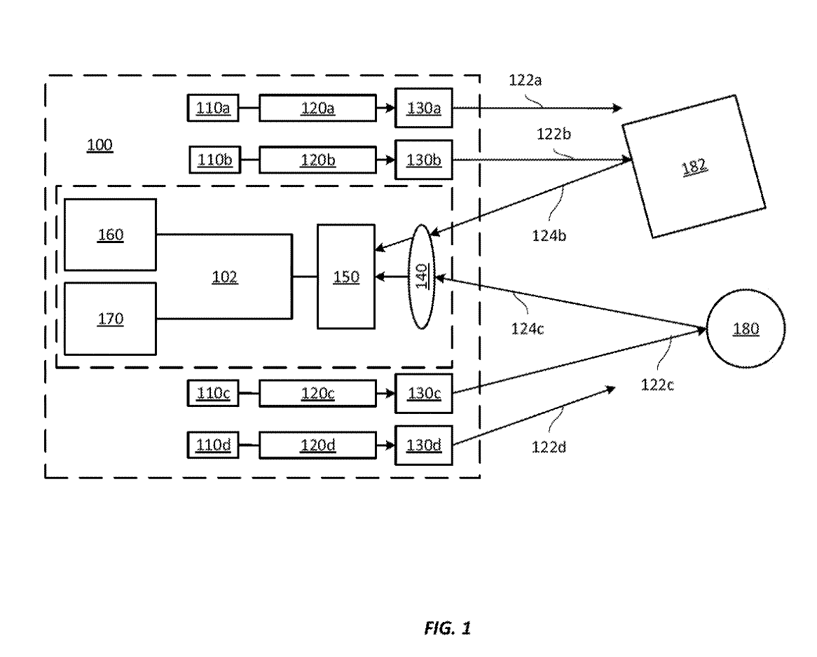

Referring now to FIG. 1, FIG. 1 shows an example system 100 for multi-beam position sensing devices for 3D object sensing/imaging. In this example, the system 100 includes four sets of laser emitter components. Each set of laser emitter components in this example includes a laser emitter driver 110a-d, a laser emitter 120a-d, and a beam deflector 130a-d. In this example system 100, there are four laser emitter drivers 110a-d, four laser emitters 120a-d, and four beam deflectors 130a-d; however, in other examples any suitable number of two or more laser emitters, with associated laser emitter drivers and beam deflectors may be employed. Further, while the system 100 in FIG. 1 shows a one-to-one correspondence between laser emitter drivers and laser emitters, and between laser emitters and beam deflectors, such a one-to-one correspondence is not required. Rather, one or more laser emitter drivers or beam deflectors may be shared by two or more laser emitters according to different examples. For example, a single laser emitter driver may be configured to output multiple drive signals or multiple modulation signals.

In this examples, the laser emitters 120a-d are evenly spaced along the same horizontal plane. However, in some examples, the laser emitters 120a-d may be arranged in different horizontal or vertical planes to increase the coverage of a field of view by emitted laser light. Further in some examples, different numbers of laser emitters may be employed. While four laser emitters 120a-d are depicted in FIG. 1, any number of two or more laser emitters may be employed in different examples.

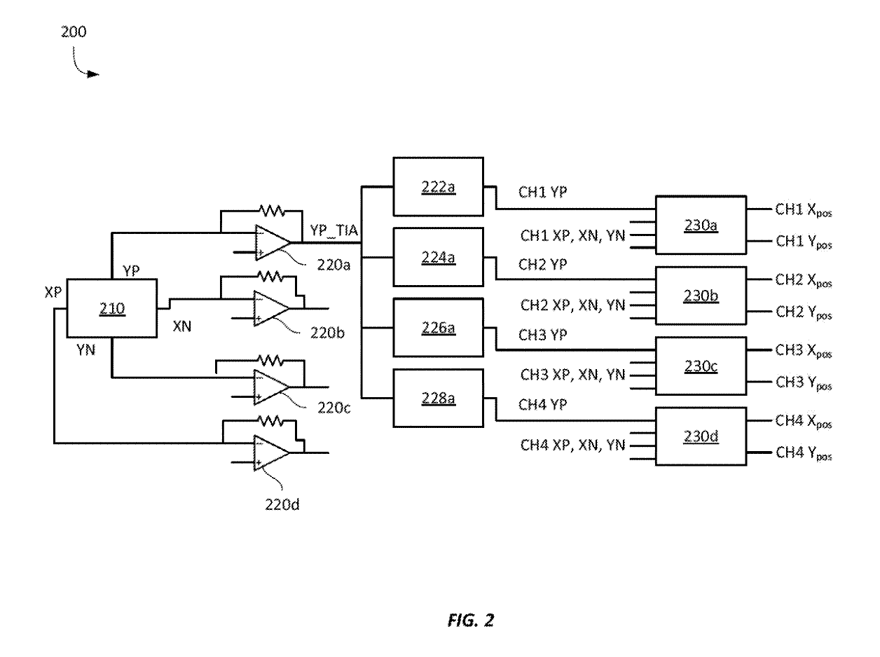

The system 100 also includes laser light detection and position determination components 102, including a lens 140, a position sensing device 150, a position determining device 160, and a channel search device 170. In this example, while multiple laser emitters 120a-d are employed, only a single position detection device 150 is employed. The lens 140 directs light onto the position detection device 150, which generates signals that indicate where on the position detection device 150 light struck. In this example, the position sensing device 150 is a position sensing diode, however, any suitable position sensing device may be used. For example, other suitable position sensing devices include an array of position sensing diodes, or one or more charged-coupled devices (CCD) or CMOS image sensors. The signals are communicated to the position determining device 160 and the channel search device 170. A more detailed discussion of the detection components, including position detection device 150, position determining device 160, and channel search device 170 is provided with respect to FIGS. 2-4 below.

While in this example, the system 100 employs only one position sensing device 150, other examples may employ multiple such position sensing devices. For example, the use of more than one position sensing device may increase the resolution or accuracy of the system's ability to detect and locate objects in a field of view.

During operation, the laser emitters 120a-d, when driven by signals from the corresponding laser emitter driver 110a-d, emit laser light 122a-d, which is deflected by the corresponding beam deflector 130a-d into a field of view, where the laser light may strike an object 180-182, and reflect back 124b-c onto the lens 140. The lens 140 may then direct the light onto the position sensing device 150. The position sensing device 150 then generate signals based on the received reflected light and transmits them to the position determining device 160.

It should be appreciated that in some examples, the light detection and determination components 102 may also include a filter that filters light outside of a range of frequencies generally corresponding to the frequencies of the emitted laser light 122a-d. It should be appreciated that the frequencies of the emitted laser light 122a-d is distinct from the modulation frequency of the emitted laser light 122a-d. For example, a laser emitter that emits red laser light at 450 THz, may modulate that laser light at a frequency of 200 kilohertz (“kHz”) based on a signal from its corresponding laser emitter driver.

Suitable modulation frequencies in different examples may be in the range of hundreds of Hz to hundreds of kHz. However, depending on the position sensing device 150 employed, modulation frequencies may be adjusted based on the frame rate limits of the position sensing device. For example, while a position sensing diode may support modulation frequencies of hundreds of kilohertz, other position sensing devices, such as CCD or CMOS image sensors may only support modulation frequencies in the range of a few hundred hertz to about 1 kHz.

The laser emitter drivers 110a-d are configured to modulate laser light emitted by the corresponding laser emitter 120a-d based on a modulation signal. In this examples, the laser emitter drivers 110a-d modulate the laser light by switching a current supplied to the corresponding laser emitter at a predetermined frequency, such as by switching a transistor. Such a modulation scheme may result in laser light pulses interspersed by periods where no laser light is emitted. In some examples, the laser emitter drivers 110a-d may instead vary an amplitude, phase, frequency, or polarization of the laser light. Further, while the example laser emitter drivers 110a-d shown in FIG. 1 modulate the laser light at a constant frequency, other examples may modulate the laser light by varying a frequency or pulse width of a modulation signal, or varying the modulation signal according to a predetermined pattern, e.g., a bit sequence.

Suitable laser emitters 120a-d may employ any suitable laser emitter device, including visible light lasers, infrared lasers, ultraviolet lasers, etc. In some applications, the strength of emitted laser light may be restricted, for example, in the context of a vehicle where light striking a person's eye likely, total (or individual) laser emitter power output may be limited, e.g., to 50 or 100 milliwatts (mw). However, by using multiple laser emitters with a single detector, example systems may be able to achieve better performance than a single emitter paired with a single detector.

The beam deflectors 130a-d include one or more minors, and change the orientation of the mirror(s) over time to change the path of emitted laser light into a field of view. For example, a beam deflector 130a-d may oscillate between two orientations. The oscillations may cause the laser light to sweep across a field of view based on the movement of the beam deflector 130a-d. In some examples, a beam deflector 130a-d may rotate continuously, while only reflecting the light within certain orientations. For example, a mirror may be affixed to or formed on one or more faces of a triangular or polygonal prism, while the other sides may have a substantially non-reflective coating. Rotation of the prism may cause laser light to reflect into a field of view only when it strikes the mirrored side of the prism. Still other styles of beam deflectors may be employed instead.

As discussed above, the example system 100 employs multiple laser emitters 120a-d, but only one position sensing device 150. However, in other examples, multiple position sensing devices 150 and multiple position determining devices 160 may be employed.

Referring now to FIG. 2, FIG. 2 shows an example receiver 200 for multi-beam position sensing devices for 3D imaging. The receiver includes a position sensing device 210, multiple transimpedance amplifiers (“TIAs”) 220a-d, multiple demodulators 222a-228a, and multiple position determining devices 230a-d. The input of each TIA 220a-d is connected to a different output of the position sensing device 210. The output of the first TIA 220a is connected to each of a group of four demodulators 222a-228a. Similarly, the outputs of each of the other TIAs 220b-d is connected to its own group of four demodulators (not shown). The outputs of the demodulators 222a-228a are provided to one of the four position determining devices 230a-d. Thus, the example receiver 200 includes a total of sixteen demodulators and four position determining devices 230a-d. While all sixteen demodulators are not shown, all sixteen inputs are shown across the four position determining devices 230a-d.

In this example, each of the four demodulators 222a-228a corresponds to one of the four laser emitters 120a-d of the system 100 of FIG. 1. Similarly, each of the position determining devices 230a-d corresponds to one of the four laser emitters 120a-d.

In this example, the position sensing device 210 is a position sensing diode. The position sensing device has four outputs, XP, XN, YP, and YN, which correspond to the position sensing device's output for the positive X-axis (XP), negative in the X-axis (XN), positive in the Y-axis (YP), and negative in the Y-axis (YP). It should be appreciated that XP and XN are not a true differential pair; the same is true of YP and YN.

Each of these four outputs represents a value which may include a combination of received reflected laser light from any or all of the four laser emitters 120a-b, each of which is referred to as a “channel” with respect to the receiver 200. Thus, the YP output signal transmitted to the first TIA 220a may include information about any or all of the four channels. Thus, the output of the first TIA 220a is transmitted to each of four demodulators 222a-228a, with each demodulator configured to demodulate a different one of the four channels, e.g., based on the modulation frequency or scheme applied to the respective laser emitter. While not shown in FIG. 2, in this example, each demodulator also receives as an input signal representing the modulation frequency applied to the respective laser emitter. For example, the modulation signal provided to the respective laser emitter driver may also be supplied to the respective demodulators. In this example, each of the four modulation signals is sent to a different demodulator—the demodulator associated with the respective laser emitter (or channel).

In this example, the YP signal from the position sensing diode 210 is provided to the first TIA 220a, which converts the signal to a voltage that is proportional to a location on the position sensing diode 210 struck by reflected laser light, and to the intensity of the reflected laser light striking the position sensing diode 210. In this example, the positive terminal of the TIA 220a is coupled to bias voltage, while the resistors are each sized at 1 MΩ, though other suitable resistors may be employed in various examples.

The demodulators 222a-228a, one for each channel, each receive the output of the first TIA 220a and determine the in-phase (“I”) and quadrature (“Q”) components of the received light signal based on modulation frequencies of each of the four laser emitter drivers 110a-d shown in FIG. 1. The I and Q signals are sent to the corresponding position determining device 230a-d. In the example shown in FIG. 2, the YP signal for channels 1-4 are sent to the corresponding position determining device 230a-d for the channel. Each demodulator 222a-228a provides an output signal to a position determining device 230a-d, which corresponds to the same laser emitter 120a-d as the respective demodulator 222a-228a. In addition to the YP signals, each position determining device 230a-d also receives XP, XN, and YN signals. The position determining devices 230a-d then determine X and Y position of the light striking the position sensing diode for each respective channel.

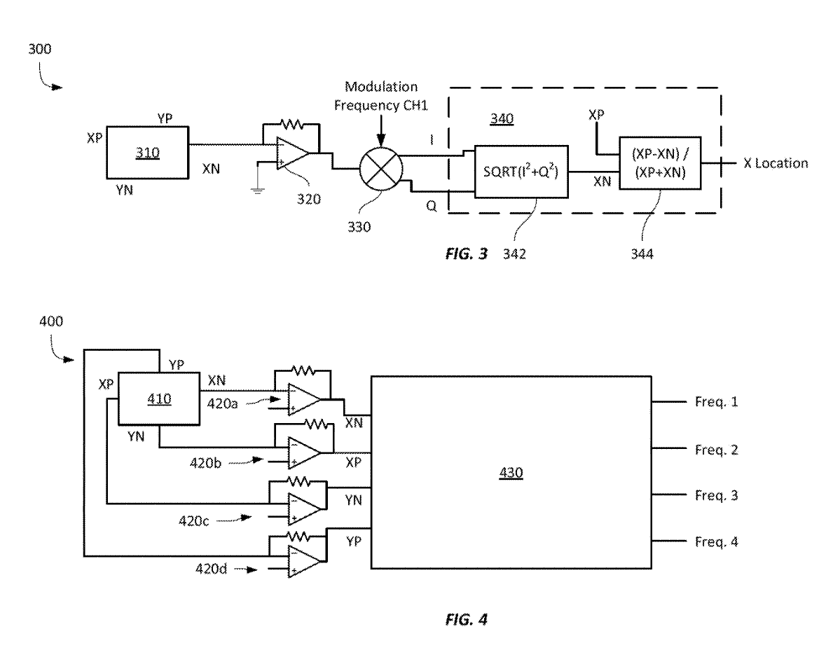

Referring now to FIG. 3, FIG. 3 shows a more detailed component diagram for processing a single channel based on the XN output from a position sensing device 310. The components for the channel processing of the XN output include a TIA 320 coupled to the XN output and to a demodulator 330. The demodulator 330 outputs I and Q signals to a position determining device 340. For clarity, all of the demodulators and position sensing devices to process received reflected light signals for all position sensing device outputs and for all channels are not shown; however, one of skill in the art would understand to replicate the respective components shown in FIG. 3 for such additional position sensing devices outputs and each additional channel according to this disclosure.

In this example, the position sensing device 310 is a position sensing diode having four outputs XP, XN, YP, and YN. The XN output signal is transmitted to the TIA 320, which converts the signal to a voltage signal as discussed above with respect to FIG. 2. The voltage signal is provided to the demodulator 330, which generates I and Q signals based on the voltage signal for the TIA 320 and the modulation frequency for the laser emitter associated with channel 1 in this example. The I and Q signals are then provided to the position determining device 340.

The position determining device 340, at block 342, after receiving the I and Q signals, calculates \sqrt{I²+Q²}, which is transmitted to block 344. Block 344 also receives the output of the same calculation for the channel 1 XP signal and then calculates the X location of received reflected laser light from the laser emitter associated with channel 1 according to the following:

$$\frac{( XP - XN )}{( XP + XN )}$$

Similar determinations are also made with respect to the YP and YN output signals to generate the Y location of received reflected laser light for channel 1. Thus, an (X, Y) coordinate on the position sensing diode may be determined for received reflected laser light originally emitted by the laser emitter associated with channel 1. Further, (X, Y) coordinates for each of channels 2-4 are also determined in the same way, thereby simultaneously providing (X, Y) coordinates for received reflected laser light from any or all of the four laser emitters 120a-d, depending on the light that struck the position sensing device 150.

In some examples, in addition to determining the (X, Y) coordinates, the position determining device 340 may also determine a time of flight (“TOF”) of received reflected laser light based on a phase shift of the reflected light and the emitted light, particularly for distant objects. The TOF may then be used to determine an approximate distance to an object that reflected the laser light. In some examples, TOF information may be limited based on a speed of the position sensing device used in the system; however, it may still provide coarse distance information.

The determined (X, Y) coordinates (and optionally, the TOF) may then be used to determine the location of an object that reflected the laser light. Further, over time as the beam deflectors, in this example, sweep the laser light across a field of view, the determined distances to one or more objects in the field of view may be used to construct a point cloud, with each point corresponding to a determined (X, Y) coordinate, and potentially a Z-coordinate based on TOF information, which may provide object profile information about the shape of an object, or may be used to recognize an object using a computer vision technique, for example.

As discussed above with respect to FIGS. 1-3, multiple lasers may be modulated according to different modulation frequencies or techniques to emit modulated laser light into a field of view to detect the presence and location of objects within the field of view. However, if other laser light is also being emitted into the field of view from laser emitters that are not part of the same system, it may cause interference. Thus, in some examples, a system for multi-beam position sensing devices for 3D imaging may determine modulation frequencies for its laser emitters based on a received ambient light signals.

It should be appreciated that for certain types of position sensing devices, e.g., CCDs or CMOS image sensors, the circuitry shown in FIGS. 2 and 3 may not be needed. Instead, a processor may receive sensor signals from the position sensing device and determine a location or locations, e.g., a pixel or pixels, at which the laser light was detected.

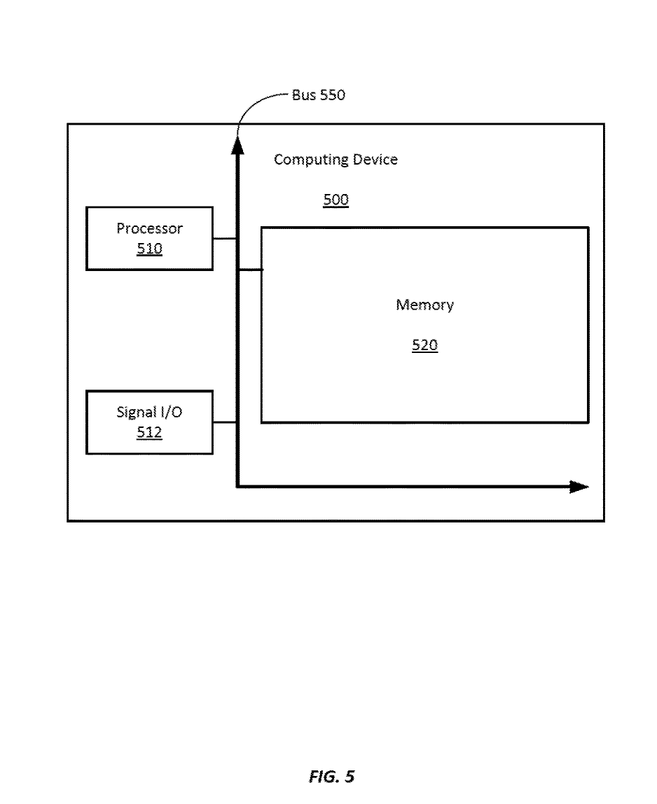

Referring now to FIG. 4, FIG. 4 shows an example system 400 for determining modulation frequencies based on received ambient light signals. The system 400 shown in FIG. 4 will be discussed with respect to the components of the system 100 shown in FIG. 1, however, the example system 400 of FIG. 4 is not restricted to use with such an example system 100. Rather, this example system 400, or other examples of systems for determining modulation frequencies based on received ambient light signals according to this disclosure, may be employed with any suitable system according to this disclosure.

This example system 400 includes a position sensing device 410, four TIAs 420a-d, and a channel search device 430. In this example, the position sensing device 410 is a position sensing diode having four outputs, XP, XN, YP, and YN. Each of the four outputs is connected to a different TIA 420a-d, which are configured as discussed above with respect to FIG. 3. Each TIA 420a-d is connected to the input of the channel search device 430.

The channel search device 430 includes a spectrum analyzer, which receives the signals from the TIAs 420a-d and converts them from the time domain into the frequency domain, e.g., using a fast Fourier transform (“FFT”) technique, to create a representation of the frequency spectrum of the modulation frequencies of detected ambient light. The channel search device 430 receives the output from the spectrum analyzer to determine modulation frequencies.

In this example, four laser emitter devices are being used, thus, the channel search device 430 searches the frequency domain for four modulation frequencies represented by a local or global minimum within the frequency spectrum. For example, the channel search device 430 may search the output bins of an FFT technique to identify the four bins having the lowest magnitude, or in some examples, the first four bins having a magnitude below a predetermined threshold. In some examples, the channel search device 430 identifies frequencies represented within the frequency spectrum below a predetermined threshold magnitude. Other techniques may specify a minimum gap in modulation frequencies for the laser emitters within the system 100, which may allow for easier differentiation between reflected received laser light from the different emitters. For example, the channel search device 430 may enforce a minimum separation of 10 kHz between modulation frequencies of each laser emitter in the system 100. In examples, the channel search device may enforce such minimum separation from ambient light sources, such as detected laser light originating from other LIDAR systems.

After determining the modulation frequencies, the channel search device 430 outputs modulation signals, each having one of the determined modulation frequencies. In the example shown in FIG. 4, the channel search device 430 outputs four modulation frequencies, each dedicated to one of the laser emitter drivers 110a-d, to modulate the corresponding laser emitter 120a-d. However, it should be appreciated that the number of modulation frequencies provided may depend on the number of laser emitters within the system. Thus, for a system having six laser emitters, the channel search device 430 may determine and output six modulation frequencies.

In some examples, the channel search device 430 may be employed before the system 100 begins transmitting laser light. However, in some examples, the channel search device 430 may operate continuously, or periodically, and may modify one or more of the modulation frequencies over time based on changes in the detected ambient light. For example, the channel search device 430 may perform a channel search once every minute or other time interval and identify new modulation frequencies, or to confirm that current modulation frequencies are adequate. The time interval need not be constant; for example, when a vehicle is travelling at higher speed and/or in an environment with a greater number of potentially interfering signals, the channel search may be performed more frequently (shorter time interval) than when it is moving more slowly or in a more isolated environment (longer time interval).

In some examples, the channel search device 430 may be implemented, at least in part, in software using, for example, a general-purpose processor or a digital signal processor, or other computing device. Referring now to FIG. 5 shows an example computing device 500 suitable for determining modulation frequencies based on received ambient light signals. In the example shown in FIG. 5, the computing device 500 includes a processor 510, a memory 520, and a signal input/output (“I/O”) interface.

The processor 510 is configured to employ bus 550 to execute program code stored in memory 520 to determine modulation frequencies based on received ambient light signals. In this example, the computing device 500 receives one or more signals from a position sensing device. For example, with respect to FIG. 4, the computing device 500 receives signals from each of the TIAs 420a-d via the signal I/O interface, which, in this example, comprises multiple general purpose I/O pins connected to the processor 510. The processor 510 receives the signals and performs an FFT technique to obtain a frequency spectrum based on the input signals. The processor 510 then searches the frequency spectrum to identify modulation frequencies, and outputs modulation signals having the modulation frequencies to laser emitter drivers, such as the laser emitter drivers 110a-d in the system 100 of FIG. 1 to drive the laser emitters 120a-d.

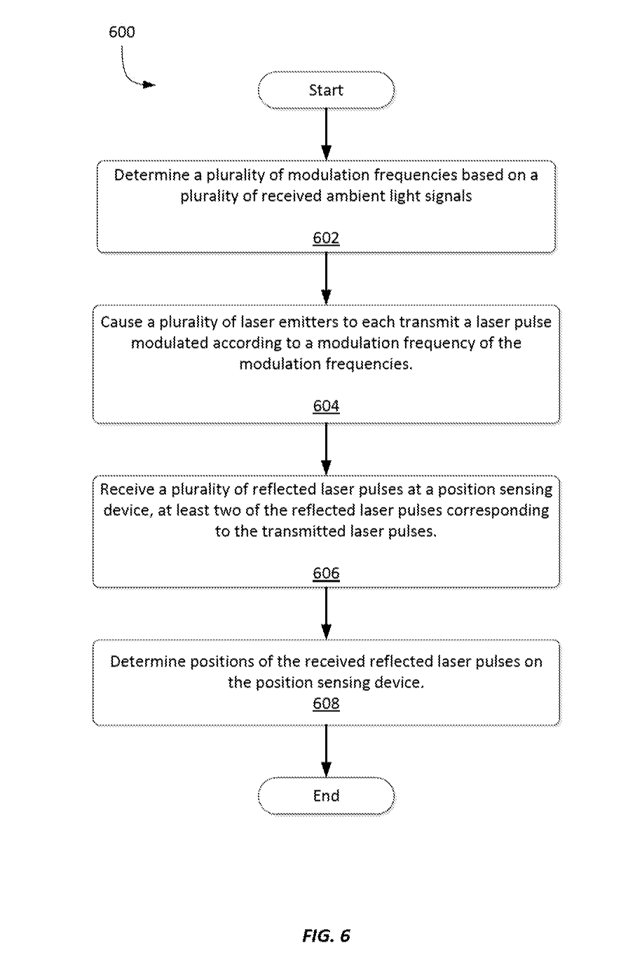

Referring now to FIG. 6, FIG. 6 illustrates an example method 600 for multi-beam position sensing devices for 3D imaging. The method 600 shown in FIG. 6 will be described with respect to the systems 100-400 shown in FIGS. 1-4, however, it should be appreciated that any suitable system according to this disclosure may be employed.

At block 602, the example system 100 determines a plurality of modulation frequencies based on a plurality of received ambient light signals. In this example, the system 100 employs its channel search device 170 to analyze the spectrum of received laser light and to identify modulation frequencies of the received laser light. For example, the channel search device 170 may perform an FFT technique to identify modulation frequencies having significant magnitudes, e.g., above a predetermined threshold, represented within the FFT frequency spectrum output. The channel search device 170 may then identify modulation frequencies having magnitudes that represent a local or global minimum within the frequency spectrum. In some examples, the channel search device 170 may instead identify modulation frequencies having a magnitude below a predetermined interference threshold.

In some examples, the channel search device 170 may decode a modulation pattern from received ambient light. For example, ambient light may be modulated according to a repeating bit pattern resulting in multiple modulation frequencies. In some examples, the channel search device may identify a bit pattern that is orthogonal to, or substantially orthogonal to a detected bit pattern.

After identifying such modulation frequencies, the method 600 proceeds to block 604.

At block 604, the example system 100 causes a plurality of laser emitters to each transmit one or more laser pulses modulated according to a modulation frequency of the determined modulation frequencies. In this example, which includes four laser emitters 120a-d, the channel search device 170 provides a different one of the determined modulation frequencies to each of the four laser emitter drivers 110a-d. Each laser emitter driver 110a-d then generates a signal to activate its respective laser emitter 120a-d and to cause the laser emitter 120a-d to output modulated laser light at the respective modulation frequencies.

In one example, the laser emitter driver 110a-d may modulate a corresponding laser emitter 120a-d by rapidly switching a switch, e.g., a transistor, to provide a square wave signal to the laser emitter 120a-d. In some examples, a laser emitter driver may modulate a constant drive signal to the laser emitter 120a-d using the determined modulation frequency to provide a modulated signal to the laser emitter 120a-d. In some examples, a determined modulation frequency may include a repeating bit pattern, which may be used to modulate a laser signal emitted by a laser emitter 120a-d.

At block 606, the example system 100 receives a plurality of reflected laser pulses at a position sensing device 150. In this example, the position sensing device 150 is a position sensing diode having multiple outputs, such as the example shown in FIGS. 2 and 3. The lens 140 directs received laser light onto the position sensing diode 150, which generates and outputs one or more signals based on the location on the diode struck by the received laser light. As discussed above, the output signals may be transmitted to other components, such as the TIAs shown in FIGS. 2-4. The TIAs may then in turn process the signals received from the position sensing diode, such as by converting the signal into a voltage that is proportional to a location on the position sensing diode 210 struck by reflected laser light. The output of each TIA may be demodulated according to one or more of the modulation frequencies at which the different laser emitters 120a-d is driven.

At block 608, the example system 100 determines positions of the received reflected laser pulses on the position sensing device 150. In this example, as discussed above with respect to FIGS. 1-4, a position sensing diode provides multiple output signals, which are converted to voltage signals by TIAs. The voltage signals are then demodulated based on the determined modulation signals used to modulate the laser light emitted by the system's laser emitters 120a-d. As discussed above, each output signal of the position sensing diode is demodulated for each of the laser emitters. Thus, in an example system employing six laser emitters, each of which is modulated according to a modulation signal, each output signal of the position sensing diode will be demodulated six times, once for each of the six laser emitters. Thus, in such an example, where the position sensing diode provides four output signals, 24 demodulated signals will be generated, six for each laser emitter or channel per output signal.

The demodulation of each of the voltage signals results in I and Q signals, which are provided to a position determining device, e.g., the position determining device 340 shown in FIG. 3. Each channel in this example has a corresponding position determining device 340, which receives I and Q signals from demodulators associated with the respective channel. Thus, each position determining device 340 determines a position on the position sensing diode where received reflected laser light originally emitted by the corresponding laser emitter struck.

To determine the position, the position determining device 340 first calculates \sqrt{I²+Q²} for each pair of received I and Q signals. These calculations are then combined to determine an (X, Y) coordinate on the position sensing diode. In this example, the position sensing diode outputs two signals for each of the X and Y axes, thus, the position determining device 340 determines the X coordinate based on the I and Q signals associated with the two X-axis outputs from the position sensing diode, referred to in this example as XN and XP. As discussed above with respect to FIG. 3, to determine the X-coordinate, the position sensing device makes the following calculation:

$$\frac{( XP - XN )}{( XP + XN )}$$

A similar calculation is made for the Y-coordinate:

$$\frac{( YP - YN )}{( YP + YN )}$$

Each position determining device 340 makes these calculations for their respective channels to determine the (X, Y) coordinates of received reflected laser light, if any, on each channel. Thus, system 100 determines the positions of the received reflected laser pulses on the position sensing device 150.

In some examples, the system 100 may further determine a position of an object in a field of view based on the determined positions of the received reflected laser pulses. For example, the position determining devices 340 may provide the (X, Y) coordinates of the received reflected laser light to a computing device, e.g., the computing device 500 shown in FIG. 5. The computing device 500 may receive (X, Y) coordinates from one or more of the position determining devices 340, e.g., via the signal I/O interface 512. After receiving the (X, Y) coordinates, the computing device 500 may generate a point cloud over time as multiple laser pulses transmitted by the laser emitters reflect from the object(s) in the field of view and are received at the position determination components 102. The point cloud may be employed to identify the presence of the object(s). Further, the computing device 500 may further employ additional information such as TOF to determine approximate distances to the object(s), particularly distant objects. Thus, the system 100 may determine the position of one or more objects in a field of view based on the determined positions of the received reflected laser pulses on the position sensing device 150.

In an embodiment where system 100 is mounted on a vehicle, ambient light may be received during a first time interval. Information indicative of frequency contributions of the ambient light may be determined (for example, by performing a Fourier transform or other frequency analysis) and used to determine modulation frequencies for the plurality of laser emitters. As noted above, rather than spacing the modulation frequencies for the laser emitters at a fixed frequency separation, the modulation frequencies can be selected based on the frequency profile of ambient light in addition to a target minimum separation between the modulation frequencies of different laser emitters. That is, for the example of N laser emitters, with the modulation frequencies ranked from lowest to highest, the frequency separation between the N=1 laser emitter (having a lowest assigned modulation frequency) and the N=2 laser emitter may be different than the frequency separation between the N=2 laser emitter and the N=3 laser emitter and so on.

Once the modulation frequencies are selected based on the frequency profile of ambient light and target minimum separation, the laser emitters generate pulses of laser light using their particular modulation frequency. The pulse width for the laser light may be between about 1 nanosecond (ns) and about 5 microseconds in some examples, though other examples use pulse widths less than about 100 ns, although other pulse widths may be used. Position sensing devices such as those described above can then be used to detect reflected portions of the transmitted pulses, while the output of the position sensing device(s) is used to detect objects, their 3D profiles, and/or the distance from the vehicle of the objects or points on the surface of the object.

As the vehicle travels, the laser emitters continue to generate light pulses using the assigned modulation frequencies, and beam deflectors may sweep the beams to sample different portions of the field of view of the vehicle to detect objects. After a certain time, and/or if there is an indication that the assigned modulation frequencies should be updated, ambient light is again detected and processed to determine modulation frequencies for each of the laser emitters. Information that may indicate the assigned modulation frequencies should be updated can be an indication of the number or density of laser emissions received, an indication that the location of the vehicle is a location that corresponds to a higher density of laser emitters (e.g., an urban location with substantial adoption of smart vehicles), an indication that interference is reducing object detection quality, etc. The techniques herein may provide for more accurate and efficient object detection, since the adaptive selection of modulation frequency may reduce the number of false data points from light detected at the position sensing device(s) that is not generated by the laser emitters and reflected by objects.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein. The term “processor” herein does not refer to software per se.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method for multi-beam position sensing comprising:
determining a plurality of modulation frequencies based on a plurality of received ambient light signals;
causing a plurality of laser emitters to each transmit a laser pulse, each laser pulse modulated according to a modulation frequency of the plurality of modulation frequencies, each laser pulse having a different modulation frequency than each of the other laser pulses;
receiving a plurality of reflected laser pulses at a position sensing device, at least two of the plurality reflected laser pulses corresponding to the transmitted laser pulses; and
determining positions of the received reflected laser pulses on the position sensing device.

2. The method of claim 1, further comprising determining a location of an object based on the received reflected laser pulses.

3. The method of claim 1, wherein determining the plurality of modulation frequencies comprises:
receiving the plurality of ambient light signals at the position sensing device; and
for each received ambient light signal, determining an ambient modulation frequency of the respective received ambient light signal; and
determining the plurality of modulation frequencies based on the ambient modulation frequencies.

4. The method of claim 3, wherein determining the plurality of modulation frequencies comprises determining a modulation frequency having an interference level below a predetermined interference threshold.

5. The method of claim 1, wherein the position sensing device comprises a position sensing diode.

6. The method of claim 5, wherein determining the positions of the received reflected laser pulses on the position sensing device comprises:
providing, by the position sensing diode, a plurality of signals associated with the received reflected laser pulses, and for each signal of the plurality of signals associated with the received reflected laser pulses:
generating, by a transimpedance amplifier, a voltage signal based the respective signal;
generating, by a demodulator, a phase signal and a quadrature signal based on the voltage signal;
generating, by a position determining device, a coordinate based on the phase and quadrature signals.

7. The method of claim 1, further comprising determining a time of flight (“TOF”) of at least one of the received reflected laser pulses, and determining a distance to an object based at least in part on the determined TOF of the at least one received reflected laser pulses.

8. A system for multi-beam position sensing comprising:
a position sensing device comprising a light sensor;
at least one lens positioned to direct received light onto the position sensing device;
a plurality of laser emitters offset from the position sensing device;
a plurality of laser drivers, each laser driver in communication with a different laser emitter of the plurality of laser emitters and configured to cause the respective laser emitter to emit a laser signal at a predetermined frequency;
a plurality of beam deflectors, each beam deflector positioned to deflect laser light emitted by a corresponding laser emitter;
an interference determination device comprising a spectrum analyzer in communication with the position sensing device to determine a frequency having an interference level below a predetermined interference threshold; and
a demodulator in communication with the position sensing device to receive signals from the position sensing device and to determine in-phase and quadrature signals based on the received signals; and
a position determination device in communication with the demodulator to receive the in-phase and quadrature signals and to determine a position based at least in part on the in-phase and quadrature signals.

9. The system of claim 8, further comprising a plurality of demodulators and plurality of position determination devices, each demodulator and each position determination device corresponding to one laser emitter of the plurality of laser emitters.

10. The system of claim 8, wherein the position sensing device comprises a position sensing diode having a plurality of outputs, and further comprising a plurality of demodulators and a plurality of position determination devices, each demodulator in communication with one of the position determination device of the plurality of position determination devices, and
the system further comprising a plurality of transimpedance amplifiers (“TIAs”), each TIA in communication with:
an output of the plurality of outputs to receive an output signal from the output, and
an input of at least one demodulator of the plurality of demodulators, each TIA in communication with a different output.

11. The system of claim 10, wherein:
the position sensing diode comprises four outputs,
the plurality of demodulators comprises a group of four demodulators for each laser emitter, each demodulator in each group in communication with a different one of the four outputs of the position sensing device;
the plurality of position determination devices comprises four position determination devices, each position determination device corresponding to one laser emitter, each position determination device in communication with a corresponding group of four demodulators to calculate the square root of the sum of the square of the in-phase signal and the square of the quadrature signal and to determine an (x,y) coordinate to determine the position.

12. The system of claim 8, further comprising a channel search device comprising a time domain to frequency domain converter, the channel search device configured to determine at least one modulation frequency based on light signals received by the position sensing device.

13. The system of claim 12, wherein the time domain to frequency domain converter comprises a fast Fourier transform (“FFT”), and wherein the channel search device is configured to determine a plurality of modulation frequencies corresponding to the plurality of laser emitters.

14. The system of claim 8, wherein the position sensing device comprises a position sensing diode.

15. A system for multi-beam position sensing comprising:
means for determining a plurality of modulation frequencies based on a plurality of received ambient light signals;
means for causing a plurality of laser emitters to each transmit a laser pulse, each laser pulse modulated according to a modulation frequency of the plurality of modulation frequencies, each laser pulse having a different modulation frequency than each of the other laser pulses;
means for receiving a plurality of reflected laser pulses at a position sensing device, at least two of the plurality reflected laser pulses corresponding to the transmitted laser pulses; and
means for determining positions of the received reflected laser pulses on the position sensing device.

16. The system of claim 15, further comprising means for determining a location of an object based on the received reflected laser pulses.

17. The system of claim 15, further comprising:
means for determining an ambient modulation frequency of the respective received ambient light signal; and
means for determining the plurality of modulation frequencies based on the ambient modulation frequencies.

18. The system of claim 17, wherein the means for determining the plurality of modulation frequencies comprises means for determining a modulation frequency having an interference level below a predetermined interference threshold.

19. The system of claim 15, wherein the means for receiving a plurality of reflected laser pulses at a position sensing device comprises a position sensing diode.

20. The system of claim 19, wherein the means for determining the positions of the received reflected laser pulses on the position sensing device comprises:
means for providing a plurality of signals associated with the received reflected laser pulses;
means for generating a voltage signal based the respective signal;
means for generating a phase signal and a quadrature signal based on the voltage signal;
means for generating a coordinate based on the phase and quadrature signals.

21. The system of claim 15, further comprising means for determining a time of flight (“TOF”) of at least one of the received reflected laser pulses.

22. A non-transitory computer-readable medium comprising processor-executable program code to cause a processor to:
determine a plurality of modulation frequencies based on a plurality of received ambient light signals;
cause a plurality of laser emitters to each transmit a laser pulse, each laser pulse modulated according to a modulation frequency of the plurality of modulation frequencies, each laser pulse having a different modulation frequency than each of the other laser pulses;
receive one or more signals from a position sensing device, the one or more signals based on a plurality of reflected laser pulses received at the position sensing device, at least two of the plurality reflected laser pulses corresponding to the transmitted laser pulses; and
determine positions of the received reflected laser pulses on the position sensing device.

23. The non-transitory computer-readable medium of claim 22, further comprising program code configured to cause a processor to determine a location of an object based on the received reflected laser pulses.

24. The non-transitory computer-readable medium of claim 22, further comprising program code configured to cause a processor to:
receive a plurality of ambient light signals from the position sensing device; and
for each received ambient light signal, determine an ambient modulation frequency of the respective received ambient light signal; and
determine the plurality of modulation frequencies based on the ambient modulation frequencies, to determine the plurality of modulation frequencies.

25. The non-transitory computer-readable medium of claim 24, further comprising program code configured to cause a processor to determine a modulation frequency having an interference level below a predetermined interference threshold, to determine at least one modulation frequency of the plurality of modulation frequencies.

26. The non-transitory computer-readable medium of claim 22, wherein the position sensing device comprises a position sensing diode.

27. The non-transitory computer-readable medium of claim 22, further comprising program code configured to cause a processor to determine a time of flight (“TOF”) of at least one of the received reflected laser pulses, and wherein determining the position is further based at least in part on the determined TOF of the at least one received reflected laser pulses.
